(19) United States
(12) Patent Application Publication
(10) Pub. No.: US 2014/0291279 A1
(43) Pub. Date: Oct. 2, 2014

(54) PILL BOTTLE TIME INDICATOR LID

(71) Applicants: Suzanne Robertos, Temecula, CA (US); Fahed Elabdallah, Temecula, CA (US)

(72) Inventors: Suzanne Robertos, Temecula, CA (US); Fahed Elabdallah, Temecula, CA (US)

(21) Appl. No.: 13/957,404

(22) Filed: Aug. 1, 2013

Related U.S. Application Data
(60) Provisional application No. 61/805,336, filed on Mar. 26, 2013.

(51) Int. Cl. A61J 1/03

(52) U.S. Cl. CPC A61J 1/03
USPC 215/365

(57) ABSTRACT

Improvements in a pill bottle time indicator lid is presented. The pill bottle time indicator lid allows a user or care giver to set an indicator for the next time medication should be taken. When a user takes the medication they can simply reset the next time that the medication can be taken. Typically medications are taken at fixed time intervals. The interval can be as small as 30 minute increments to allow a user who takes medications outside of hour indicators or sleeps past an hour indicator to adjust the time in smaller time increments than an hour. A user can remove the provided lid and replace the standard lid with the time indicator lid. The time indicating lid can include security locks to prevent removal by children, but can also be made simple to remove by an elderly patient.

### CROSS REFERENCE TO RELATED APPLICATIONS

This application claims the benefit of Provisional Application Ser. No. 61/805,336 filed on Mar. 26, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in the lid of a pill bottle. More particularly, the present pill bottle lid dispenser with a user settable time indicator on the lid that can be retrofit into standard pill bottles to allow a user to take a pill and then set the time for the current pill was administered or the time for the next pill to be taken.

2. Description of Related Art including Information Disclosed Under 37 CFR 1.97 and 1.98

When a patient is prescribed pills they are often given a pill bottle with instructions for when to take the pills within the bottle. Many people have multiple different pills where each pill must be taken at different time intervals. Remembering when the last and next pill that needs to be taken is difficult without some type of record or indicator. For some people remembering when to take the next pill can be difficult. Without some indicator on when a next pill needs to be taken a patient can easily overmedicate by taking multiple pills or under medicate by not taking enough pills. Other people may over or under medicate either intentionally or by accident. There have been several attempts to solve this issue by providing a time indicator on a replacement lid.

A number of patents and or publications have been made to address these issues. Exemplary examples of patents and or publication that try to address this/these problem(s) are identified and discussed below.

U.S. Pat. No. 3,762,601 issued on Oct. 2, 1973 discloses a cabinet for dispensing medicines at predetermined times. This patent is for a cabinet with multiple doors. Each door is programmable to open at a preprogrammed time to allow access to the medicine behind each door. This patent does not operate to fit on the top of a pill dispenser bottle, and once the door is opened the patient can access the entire contents behind each door.

U.S. Pat. No. 4,432,300 issued Feb. 21, 1984 to Esther B. Lyss discloses a lid for a pill dispenser where the lid has an indexable reminder to identify when the next pill must be taken. While this lid fits on top of a pill dispenser it does not notify the person by having an indicator that shows a particular time and does not reduce the potential for a person from overmedicating by indicating the proper time to take the next medication.

U.S. Pat. No. 5,299,701 issued on Apr. 5, 1994 to Allen Barker et al., discloses an Indicator Cap. The indicator cap has a tabbed indexing window. The tabs allow the user to set the indicator to finite positions. While the indicator allows for the setting of a time, a user can accidentally rotate the lid and set an incorrect time. The lid further does not include and AM/PM indicator.

U.S Publication number 2011/0011883 that was published on Jan. 20, 2011 to Mohamed Farid Nakkouri discloses a single pill distributing cap for use on pill bottles. The lid only dispenses one pill at a time to prevent the entire contents from being spilled. While this lid only dispenses one pill at a time it does not prevent a person from setting or resetting the wrong time to take the next medication to access the pill(s) after the proper time interval.

What is needed is a lid for a standard pill dispensing bottle. The lid should be settable for 12 hour interval with an AM/PM indicator to allow the user to view the proper time to take the next medication. The proposed pill bottle lid dispenser with a time indicator provides a solution to this problem.

### BRIEF SUMMARY OF THE INVENTION

It is an object of the pill bottle time indicator lid to provide a lid that a user or care giver can set to indicate the time medication was currently administered or next time medication can be taken. When a user takes the medication, they can simply set the time the medication was taken, or set the time to the next time the medication can be taken. Typically medications are taken at fixed time intervals. The interval can be as small as 30 minute increments to allow a user who takes medications outside of hour indicators or sleep past an hour indicator to adjust the time in smaller time increments than an hour.

It is an object of the pill bottle time indicator lid to be configured to fit onto some existing pill bottles. Pill bottles come in a variety of sizes and threads. The pill bottle time indicator can be made to operate with some common bottle sizes and threads and can be configured to operate with a custom bottle that works with the pill bottle time indicator lid. If the pill bottle time indicator is configured to fit on a currently available bottle a user can remove the provided lid and replace the standard lid with the time indicator lid.

It is an object of the pill bottle time indicator lid to have a lid that includes security locks to reduce removal by children, but can also be made simple to remove by an elderly patient. The angled side of the notches or teeth on the pill bottle time indicator lid allows the child resistant mechanism to slide the lid and not be able to be opened, unless the outer lid is pushed on and turned to open the lid. The notches or teeth can also be made with two straight sides which will not have a child resistant mechanism. The pill bottle time indicator lid can also have notches or teeth with a combination of a straight and sloped side. This way, when it is manufactured, the outer cap notches or teeth can do both jobs (child and non-child resistant) and the inside cap notches or teeth will determine if the cap will be child resistant or not.

It is another object of the pill bottle time indicator lid for the timer lid to require the patient to lift the lid to set the time. The lid is configured with two major components that engage upon each other with teeth or notches that provide time increments of 30 minutes each. The teeth are configured with a straight side and an angled, two straight sides, or a combination of the angled and straight side. The straight side allows a person to screw the lid on the bottle without changing the time setting. The outer lid must be lifted where the top and bottom notches or teeth are no longer engaging one another and rotated in either direction to set the time the pill was administered or what time the next pill should be administered. Angled sides allow the outer lid to slip and not open the lid. This is the child-resistant feature. In order to open the lid, a user will need to push down on outer lid and twist counter clockwise. If the angled sides are replaced with straight sides, a user would simply turn to open or close. A user would still need to lift so the notches disengage and rotate in either direction to set time.

It is still another object of the pill bottle time indicator lid to have an AM PM indicator. The AM/PM indicator allows a person to set a time interval of equal to or greater than 12 hours. Often medication must be taken in the morning and in the evening. The AM/PM indicator allows a user to simply slide the AM/PM indicator from one setting to another to change from morning to evening or vice versa without requiring the lid to be rotated.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the pill bottle time indicator lid installed on a pill bottle.

FIG. 2 shows a perspective exploded view of the pill bottle time indicator lid.

FIG. 3A-3E shows various views of the outer ring.

FIG. 4A-4D shows various views of the inner ring.

FIG. 5 shows a perspective view of the AM/PM retainer.

FIG. 6 shows a perspective view or the AM/PM slider.

FIG. 7 shows a perspective view of the AM/PM retainer and slider.

### DETAILED DESCRIPTION OF THE INVENTION

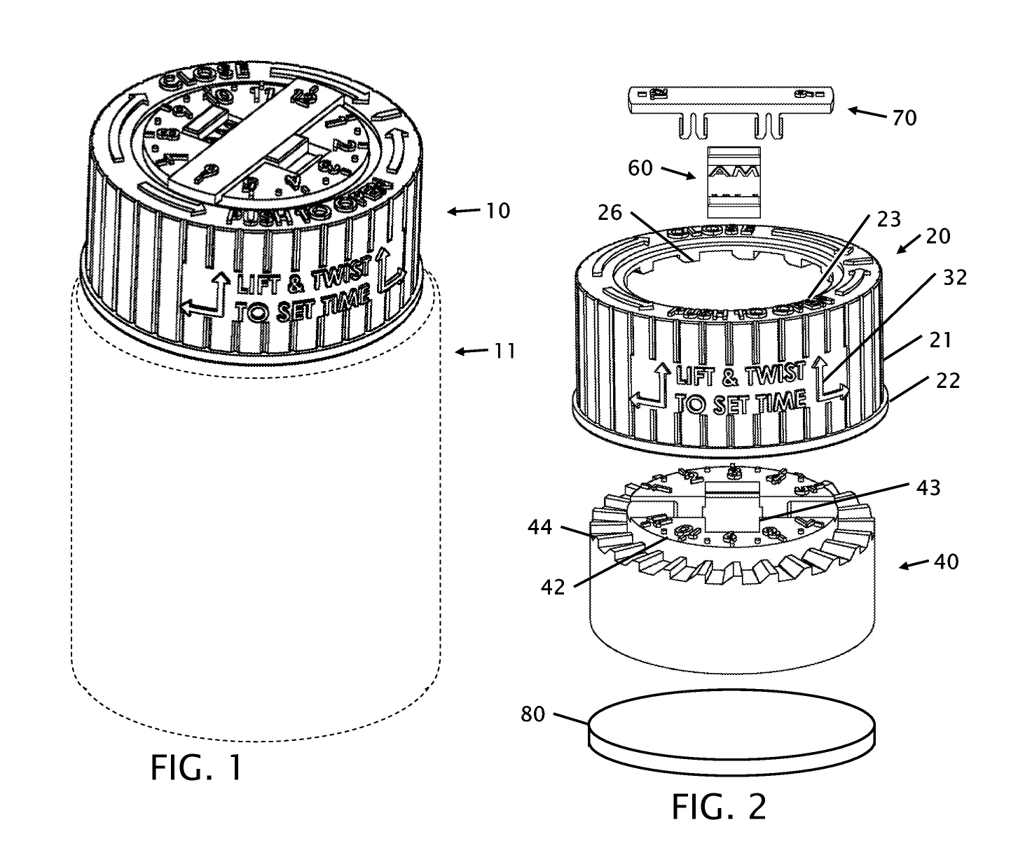

FIG. 1 shows a perspective view of the pill bottle time indicator lid 10 installed on an existing pill bottle 11 or on a custom pill bottle designed to work with the pill bottle time indicator lid. Pill bottles come in a variety of sizes and threads. The pill bottle time indicator can be made to operate with some common bottle sizes and threads and can be configured to operate with a custom bottle that works with the pill bottle time indicator lid. If the pill bottle time indicator is configured to fit on a currently available bottle a user can remove the provided lid and replace the standard lid with the time indicator lid. In the preferred embodiment the majority of the components that form the pill bottle time indicator are made from plastics including but not limited to ABS, PVC, polyester nylon high density polyethylene or polypropylene. The components are further preferably made from a molding process where post processing such as, but not limited to, printing, snapping together, bonding or other post processes are performed to create the finished pill bottle time indicating lid 10 as shown assembled in FIG. 1.

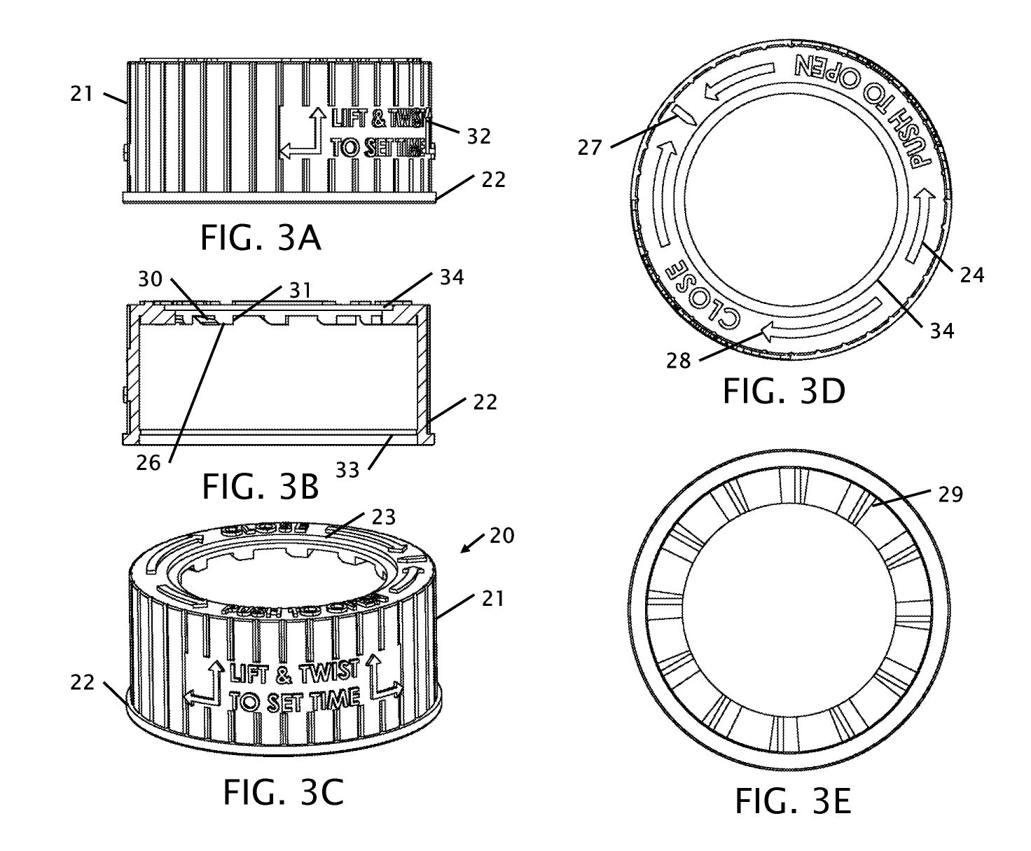

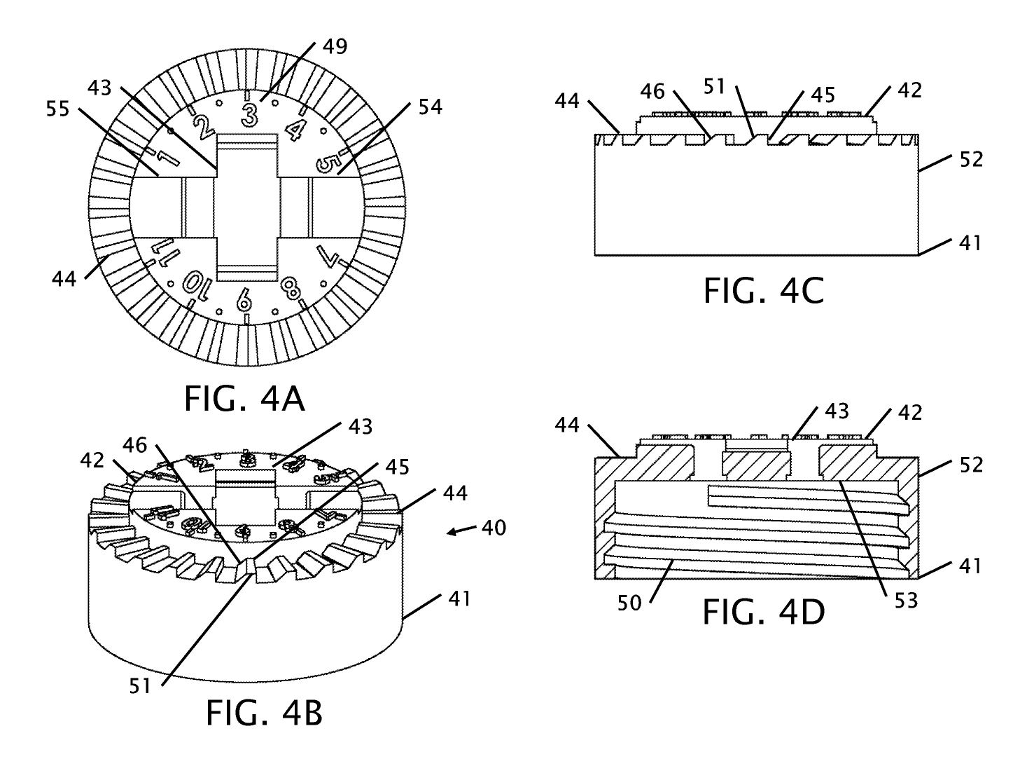

FIG. 2 shows a perspective exploded view of the pill bottle time indicator lid. The pill bottle time indicator lid is configured with an inner ring 40 that is configured for securing onto a medication container 11, as shown in FIG. 1. An outer ring 20 that is configured for engagement onto said inner ring 40 and allows for at least a portion of the inner ring 40 to protrude through an opening 23 in the outer ring 20. The outer ring 20 has a series of gripping ridges 21 to allow a person to grip the pill bottle time indicator lid 10 with greater ease. The outer edge of the outer rim may show instructions 32 to set the time on the lid. While the instructions are shown in the outer ring, the instructions are optional, and can also be placed at alternative locations on the lid and or the bottle. A bottom lip 22 on the outer ring 20 allows a user to tactfully identify the operable end of the pill bottle in the dark or without looking. Inside the outer cap 20 there can be a small ring 33 (shown in FIG. 3B) that goes around the inner cavity. This allows a limit to how far the outside cap 20 can be lifted so the outside cap 20 cannot be lift so far up that it damages the AM/PM retainer 70. The inner ring 40 is further shown having a recess 43 for an AM/PM slider 60 indicator. The inner ring 40 is further shown having another recess for the AM/PM retainer 70, shown in FIG. 4A as items 54 and 55.

The AM/PM slider 60 indicator is configured to engage into the inner ring 40 in a pocket 43. The AM/PM slider 60 is retained under an AM/PM retainer 70. The AM/PM indicator slider 60 allows a person to set a time interval of equal to or greater than 12 hours. Often medication must be taken in the morning and in the evening. The AM/PM indicator slider 60 allows a user to simply slide the AM/PM indicator slider 60 from one setting to another to change from morning to evening or vice versa without requiring the lid to be rotated. The outer ring 20 with a series of angled, straight or a combination of angled and straight teeth 26 that engage onto said inner ring 40 with a series of angled, straight or a combination of angled and straight teeth 44 that provide a time indication for a medication that is retained within said medication container 11, as shown in FIG. 1. The AM/PM indicator slider 60 fits into the inner ring 40 where it is essentially flush with the top 42 of the inner ring to reduce accidental displacement of the AM/PM indicator slider 60. An air tight cushion or seal 80 allows the inner ring 40 to seal with the medication container 11. The AM/PM retainer 70 fits on top of the AM/PM tab 60 and into the recess on the inner ring 40 where it is essentially flush with the face of inner ring 42.

FIG. 3A-3E shows various views of the outer ring 20. The outer ring 20 is created with an outer cylindrical wall with one open end and one partially closed end. The outside of the cylindrical wall has a series of gripping ridges 21 to allow a person to grip the pill bottle time indicator lid 10 with greater ease. A bottom lip 22 on the outer ring 20 allows a user to tactfully identify the operable end of the pill bottle in the dark or without looking. The outer top surface shown in FIG. 3D shows indicia that is molded printed or otherwise marked or formed into the top of the outer ring 20. These indicia provides basic instructions for rotating directions for opening 24 and closing 28 the outer ring 20 on a medication bottle. The marking indicia are shown for reference and could be as shown, as a variation or absent from the lid and or bottle. The outer edge of the outer rim also shows instructions 32 to set the time on the lid and also this marking indicia are shown for reference and could be as shown, as a variation or absent from the lid and or bottle. A pointer 27 provides an indication of the time for the time a medication was administered or the next administration of the medication. This indicator 27 points to time indicia, such as 49 from FIG. 4A, that is visible through the central opening 23 of the outer ring 20. Inside the outer cap there can be a small ring 33 that goes around the inner cavity. This allows there to be a limit to how far the outside cap can lift so it cannot lift so far up and damage the AM/PM retainer. Within the inside of outer ring 20 a series of tabs 29 exist. The innermost ring 34 on the top of the outer ring 20 is where each end of the AM/PM retainer 70 sits on top of said outer ring 20 to hold the outer ring 20 in place.

The tab(s) 29 or notches or teeth can be at an angle on one side (child-resistant), straight on either side (non-Child-Resistant), or both. The tab(s) may have a small straight side(s) with an angle depending on how inner cap teeth are manufactured can be either child or non-child resistant. The tabs 29 have a bottom surface 26, a clockwise or left surface 31 and a counter-clockwise or right surface 30. These tabs 29 engage onto teeth located in the inner ring as shown and described in FIGS. 4A to 4D. The inner and outer rings are configured with these teeth to engage upon each other to provide time setting increments of between 15 minutes and 4 hours, but more preferably between 30 minutes (in the embodiment shown) and 2 hours. While increments of 30 minutes are shown, shorter or longer time increments are contemplated. The inner ring 40 sits under outer ring 20, but all the 3 components (20, 40, and 60) are being retained by the AM/PM retainer 70. The AM/PM retainer 70 attaches to inner cap 40 by welding, glue, prongs of some sort, or some other binding agent. The holder tab holds the AM/PM tab in place, but also lays on top of the inner ring 34 that is located on the outer cap. Therefore it is also holding the outer cap together with the AM/PM tab onto the inner cap.

FIG. 4A-4D shows various views of the inner ring 40. The inner ring 40 is configured to a bottom 41 fits within the recess in the outer ring 20. The outer cap can have a small ring on the inside of it to help prevent lifting the outer cap too far up and damaging AM/PM Retainer 70. It just allows for some pressure if lifted too high. The outer side 52 of the inner ring 40 is configures to fit within the inside diameter of the outer ring 20. An outer rim 44 of the inner ring 40 has a series of teeth 51 that are configured with a straight side 45 and an angled side 46. The tabs 51 or notches or teeth can be at an angle on one side (child-resistant), straight on either side (non-Child-Resistant), or the tabs may have a combination of a straight side with an angle. The straight side 45 allows a person to close the lid without changing the set time. A person pushes down on the outer lid and turns to open the child-resistant feature. Rotating the lid in the opposite direction allows the angled side 46 teeth to slip with notches in outer ring 20 for the child resistant mechanism. If the angled sides 46 are not at an angle, but instead are straight, it allows the bottle to open without the child resistant mechanism. To set the time, the outer cap is lifted where none of the notches are now engaged, and turned to the right or left. Then the lid is set down when it is on the correct time to re-engage.

The inside of the inner ring 40 has threads 50 for engaging the inner ring 40 onto an existing or in a custom medication bottle. The inside of the inner ring 40 has a flat surface where the inner ring can seal the lid 10 with the cushion or seal 80, from FIG. 2 against the upper rim of a medication bottle 11. The AM/PM retainer 70 holds the AM/PM tab 60 in place, but also lays on top of the innermost ring 34 (shown in FIG. 3) that is located on the outer cap. The AM/PM retainer 70 can attach to the inner cap 40 with a variety of methods including but not limited to glue, ultrasonic welding, prongs, or any other equivalent retention mechanism or some other binding agent.

On the top 42 of the inner ring 40 there are indicia that indicate the time in hours 49. A user can set the indicator on the hour of on the half hour. The top 42 of the inner ring 40 also has a recess 43 for the AM/PM indicator 60 (not shown) as well as other recesses

another recess 54 and 55 is for securing AM/PM retainer 70 to lock the inner ring to the outer ring and then retains the AM/PM indicator. The AM/PM retainer 70 can be attached with prongs, notches, tabs or equivalent into the retainer in recesses 54 and 55. The AM/PM retainer 70 can also be attached by removing notch 73 and the holes on recesses 54 and 55 and bond with glue, welding, or any other equivalent retention mechanism or some other binding agent onto inner ring 40. Within this recess the AM/PM retainer 70 holds the AM/PM indicator 60.

The AM 47/PM 48 indication allows a person to set a time interval of equal to or greater than 12 hours. Often medication must be taken in the morning and in the evening. The AM 47/PM 48 indicator 60 allows a user to simply slide the AM 47/PM 48 indicator 60, from one setting to another to change from morning to evening or vice versa without requiring the lid to be rotated. The AM/PM indicator 60 is shown and described in more detail in FIG. 6.

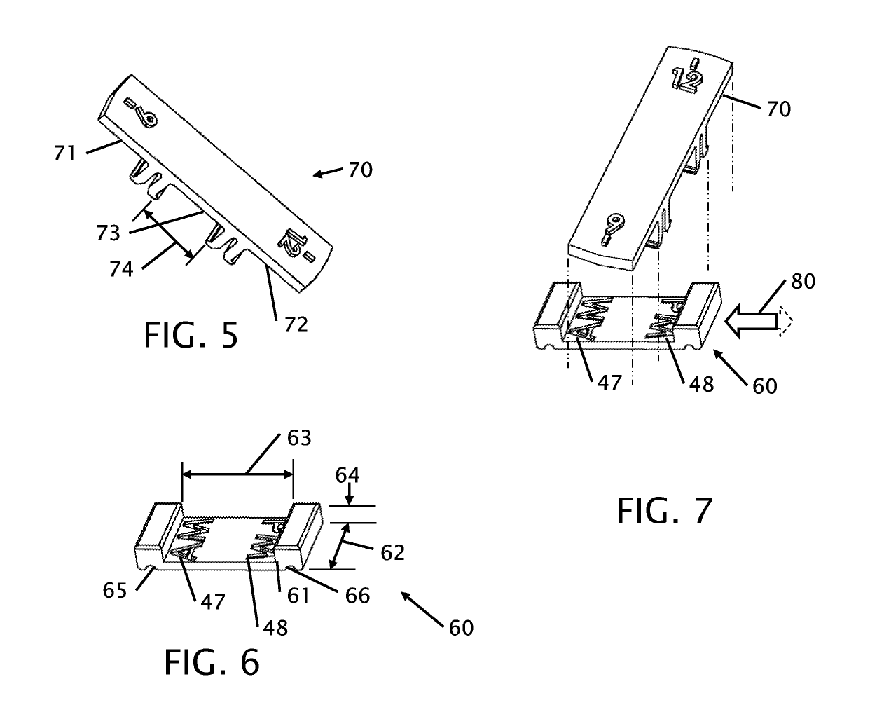

FIG. 5 shows a perspective view of the AM/PM retainer 70. The retainer 70 bridges the recess opening 43 in the inner ring 40. The AM/PM retainer 70 also bridges the AM/PM slider 60. The AM/PM retainer 70 is essentially a long slender member with a notch 73 where the AM/PM slider 60 can move under the AM/PM retainer 70. The notch 73 can be removed and the AM/PM retainer 70 can be attached to the inner cap 40 by welding, glue, prongs of some sort, or some other binding agent or design. On the sides of the AM/PM retainer 70 are flat areas 71 and 72 that rest in the recesses 54 and 55 (shown in FIG. 4. The very ends of the flat areas 71 and 72 lay on top of the innermost ring 34 that is located on outer ring 20. The flat areas 71 and 72 holding the outer ring 20 on that innermost ring 34 to secure the outer ring 20 to the inner ring 40. The recess 73 in the AM/PM retainer 70 is sized 74 for clearance of the AM/PM slider 60. The AM/PM retainer 70 is planar from 71 all the way to 72. The notch 73 can be removed completely and changed from a notch to tabs, prongs, glue, welding to be attached in any way around the AM/PM indicator 60. In another contemplated embodiment the holes and the notches securing mechanism can be removed and the AM/PM indicator 70 can be bonded to the inner ring 40.

FIG. 6 shows a perspective view or the AM/PM slider 60 and FIG. 7 shows a perspective view of the AM/PM retainer 70 and slider 60. The AM/PM slider 60 is essentially “U” shaped with two vertical 64 edges 61 that bridges the flat bottom of the AM/ PM slider 60. The width 62 of the AM/PM slider 60 is sized to fit within the recess 43 in inner ring 40. The length 63 of the AM/PM slider 60 allows the AM/PM slider 60 to cover either the AM 47 or the PM 48 in the recess 43 in the inner ring 40 by sliding 80 the AM/PM slider 60 to one side or the other. The AM/PM retainer 70 is secured or bonded to the inner ring 40 to retain the lid 10 as a single unit. Under AM/PM indicator 60 are two indentation areas 65 and 66 that fit into two bumps on the recess 43 to keep AM/PM indicator 60 from sliding back and forth on its own.

Thus, specific embodiments of a pill bottle time indicator lid has been disclosed. It should be apparent, however, to those skilled in the art that many more modifications besides those described are possible without departing from the inventive concepts herein. The inventive subject matter, therefore, is not to be restricted except in the spirit of the appended claims.

1. A pill bottle time indicator lid comprising:
an inner ring that is configured for securing onto a medication container;
an outer ring that is configured for engagement onto said inner ring;
said inner ring further having a recess for an AM/PM indicator;
an AM/PM slider configured to engage into said inner ring, and
wherein said outer ring engages onto said inner ring with a series of angled teeth that provide a time indication for a medication that is retained within said medication container.

2. The pill bottle time indicator lid according to claim 1 wherein that further includes an AM/PM slider.

3. The pill bottle time indicator lid according to claim 2 wherein said AM/PM keeper is with a slider that covers one of an AM or a PM indicator.

4. The pill bottle time indicator lid according to claim 2 wherein said AM/PM slider is made from plastic or metal.

5. The pill bottle time indicator lid according to claim 2 wherein said AM/PM indicator is an indicia on said inner ring.

6. The pill bottle time indicator lid according to claim 2 wherein said AM/PM indicator slider allows a user to set a time interval of equal to or greater than 12 hours.

7. The pill bottle time indicator lid according to claim 1 wherein said AM/PM slider is retained by a keeper.

8. The pill bottle time indicator lid according to claim 1 wherein said outer ring is made from a molding or a casting.

9. The pill bottle time indicator lid according to claim 1 wherein said outer ring has between six and 96 teeth.

10. The pill bottle time indicator lid according to wherein claim 9 said outer ring has more preferably between 12 and 48 teeth.

11. The pill bottle time indicator lid according to claim 9 wherein said teeth in said outer ring correspond to time intervals.

12. The pill bottle time indicator lid according to claim 1 wherein said inner ring is made from a molding or a casting.

13. The pill bottle time indicator lid according to claim 1 wherein said inner ring has between six and 96 teeth.

14. The pill bottle time indicator lid according to claim 13 wherein said inner ring has more preferably between 12 and 48 teeth.

15. The pill bottle time indicator lid according to claim 13 wherein said teeth in said inner ring correspond to time intervals.

16. The pill bottle time indicator lid according to claim 1 wherein said angled teeth are angled differently on each side to provide a gripping force in a first direction of rotation and a slipping in an opposing direction of rotation from said first direction.

17. The pill bottle time indicator lid according to claim 1 wherein said outer ring is configured for engagement said inner ring and allows for at least a portion of said inner ring to protrude through an opening in said outer ring.

18. The pill bottle time indicator lid according to claim 1 wherein an outer edge of said outer rim also includes instructions to set a time on said lid.

19. The pill bottle time indicator lid according to claim 1 wherein said outer ring has a bottom lip to allow a user to tactfully identify an operable end of said pill bottle time indicator.

20. The pill bottle time indicator lid according to claim 1 further includes a seal to allow said inner ring to seal with a medication container.
